(19) United States
(12) Patent Application Publication
(10) Pub. No.: US 2014/0227673 A1
(43) Pub. Date: Aug. 14, 2014

(54) METHOD AND SYSTEM FOR IMPLEMENTING A COMPREHENSIVE, NATION-WIDE, CLOUD-BASED EDUCATION SUPPORT PLATFORM

(71) Applicant: Hani Yousef, Alsawan (AE)

(72) Inventor: Hani Yousef, Alsawan (AE)

(21) Appl. No.: 13/763,953

(22) Filed: Feb. 11, 2013

(51) Int. Cl. G09B 5/00

(52) U.S. Cl. CPC G09B 5/00
USPC 434/350

(57) ABSTRACT

A system is disclosed for a software-as-a-service platform supporting every level of a national educational system. The system organizes users into subgroups based upon the users' level and function in the educational hierarchy; for example, teachers or parents at school could share a user group. The system provides platforms for email, and collaborative tools, live and on-demand streaming of lessons, recreation, and personal web pages and data spaces. User access is controlled by groups or individual accounts, and any portion of the platform may be private or public. Also disclosed is a method for the implementation of the system.

### TECHNICAL FIELD

Embodiments of the present invention relate generally to cloud computing and Software-as-a-service (SaaS), and particularly to information technology solutions for education systems.

### BACKGROUND ART

Computer-based educational products generally fall into two categories: education support software and virtual schools. Education support software is a program or suite of programs designed to facilitate conventional school instruction by migrating some academic tasks to a program on a network, usually the internet. These programs, which may be accessible through web browsers, make it possible for teachers to post assignments, class notes, syllabi, and other instructions to a virtual location such as a portal that students can reach from any internet enabled device if they use the correct logon information. Students can post their homework assignments and take-home exams to the same virtual location, where instructors can grade them, and then post assignment-specific and cumulative grades. There may also be discussion boards, electronic mail list-serves, and other communication tools to allow for extended class discussions and collaboration in a secure, controlled environment. In addition, some versions allow students to do some of their administrative chores, such as tuition payment and registration, online. These products often have different levels of security, and correspondingly different degrees of access to tools, for instructors and for students. Architecturally, these programs tend to be run mostly, but not exclusively, on servers. Users' computers access the programs via web browsers or similar programs, and the discussion boards, assignment and grade posting pages, and pages for the submission of papers, are managed by the server to which the web browser or similar program navigates. However, these programs generally rely on users' access to general purpose personal computers, whose in-system productivity tools, such as word-processing programs, provide a more comprehensive set of document production and computing tools that in practice function to augment and complete the server-based product.

The principal drawback of the education-support software products lies in their lack of breadth. The methods and systems that currently exist are generally designed to perform a small number of tasks well. They can be excellent for exchanging documents and information, for example, but they do not attempt to provide support for everything that a student would typically use to complete an assignment. Likewise, they restrict themselves as a rule to the needs of faculty and students as they pertain to the classes themselves, managing purely academic data exchange along with such basic administrative procedures that students and faculty must engage in to register for courses, collect course materials, and purchase textbooks and the courses themselves. Any single educational institution necessarily has a large range of employees and officers that do not engage in academic pursuits per se, but whose activities are vital for the institution's continuing function, such as administrative tasks and activities. The currently available education support products are not designed to provide support for the broader scope of tasks that support education.

The other kind of computer-based educational product that currently exists is known as a virtual school. Virtual schools attempt to replicate some or all of the scholastic experience itself in virtual, computerized form. Initial versions involved the teacher and each student sitting at computer consoles in a classroom, at which students could view class notes and submit questions or quiz answers to the teacher. More recent variants tend to reside online, and in many cases attempt entirely to supplant traditional learning environments. To that end, they provide correspondence study software that enables students to enroll in, study at, and matriculate through or graduate from an entire academic program, such as a primary school or university, from a personal computer in the home. These online virtual schools can provide video instruction, as well as web-based completion of assignments and grading, and registration and tuition. As such, they often incorporate some education support software in their overall product.

Whether video correspondence educational products can truly replace live instruction is a matter of ongoing debate. Such products certainly appear to have a role to play in modern education, and have already become a very popular way to prepare for professional and licensing examinations. However, as with education support software, they are generally limited to creating computer simulations of the student and teacher experiences. They do not provide information technology solutions to the back end administrators and managers of the school itself. Furthermore, both virtual schools and education support software tend to be packaged in institution-specific instances, and designed to address specific categories of educational institutions, such as universities or primary schools. Many educational institutions, however, exist as part of a wider regional system. A United States public middle school, for one example, represents only one link in the chain of learning environments in a school district, which children follow from as early as age three in some preschools all the way to high school graduation at the cusp of adulthood. Furthermore, each school district is only a single strand in a state-wide network of similar districts, all under the jurisdiction of a state-level education department responsible for setting and enforcing curriculum guidelines and quality standards, arranging and coordinating state-wide funding, and negotiating contracts with unions, among many other tasks. Finally, the United States Department of Education sets national standards and disburses funds to states, local jurisdictions, and individual schools through an array of programs and initiatives. Universities often have similar super-institutional systematic coordination; this is perhaps most obvious in state schools, which are explicitly part of state government, but even private institutions coordinate with state and national governments through student loan and scholarship programs, as well as an extremely diverse set of funding initiatives.

In the face of this complex web of administrative and educational bodies, existing computerized products have chosen to specialize. Students and workers that switch between districts and schools carry their work, record, and financial needs with them piecemeal, using an inconsistent and heterogeneous mixture of paper, computer files, and recreation from scratch of necessary data. Students also generally have to receive a brand-new set of log-on credentials at each new institution, and go through the often frustrating process of registering for whatever local information technology system is in place. Finally, the lack of a truly comprehensive educational platform delivered via network means that individual schools have to bear the cost of maintaining data and server centers, and to bear the responsibility for network and data security. This in turn requires the employment of information technology teams and the dedication of facilities for information technology tasks, resulting in an inefficient use of the limited funds all schools must use to operate. Likewise, this patchwork of information technology centers is cumbersome to manage from a state or nation-wide central authority, as it does not provide the technical means to control access, content, and security from a central location.

Software-as-a-service (SaaS) is a nascent but growing part of the software industry, and has been used effectively for business solutions and various other things, but has not yet been used extensively in the academic realm. SaaS users utilize a network, typically the internet, to access the SaaS product. The only other tasks the customer's computer or similar device, known as the “client” device must perform are user-interface tasks: relaying user input via the network and displaying data delivered via the network. All data storage, processing, security, and manipulation tasks are performed by a “cloud” of server-side facilities whose inner workings are invisible to the client. This approach has many advantages. It renders the customer independent from any particular geographical location and client machine, as all of the customer's data and software are immediately useable upon logging onto the network from anywhere in the world. SaaS also can help customers reduce their information technology expenses to a great degree. Because all of the non-user interface computing tasks occur in the cloud, the SaaS service provider is able to take sole responsibility for the great majority of infrastructure, computing, and data storage costs. For the same reason, the SaaS provider bears the responsibility for almost all cyber-security. This enables those duties, which have become increasingly complicated with the advance of technology, to be placed in the hands of specialists whose only concern is safe, efficient computing. Customers in turn are freed to perform the tasks to which they are best suited by virtue of their profession, training, and innate abilities. The SaaS provider can use a number of approaches to make its system robust, including data backup systems, distributed or load-balanced storage of data within a set of servers, and distribution of data centers in varied geographic locations. Because they inherently pool infrastructure costs, SaaS providers can eliminate redundant expenditures and concentrate on various kinds of disaster-proofing, including generators for use in power outages, and dedicated security teams. Properly implemented, SaaS can perform some computing tasks far more safely and efficiently than traditional client-side software.

SaaS is still a new technology. It is beginning to proliferate and spread into new industries, but as yet has not become as ubiquitous as older software models. In particular, SaaS has not thus far made many inroads into education.

### SUMMARY OF THE EMBODIMENTS

It is therefore an object of this invention to provide a comprehensive, stable, and flexible support platform for the computing needs of an entire national educational system, from the top governmental administration to the individual students, teachers, and parents. It is a further object of this invention to fulfill all of an educational system's computing needs using a centrally administered SaaS platform. It is a yet further object of this invention to use SaaS principles to save information technology and computer management costs for schools, school districts, and educational administrative offices. It is a further object still of this invention to better prepare the educational system for natural disasters and cybernetic security breeches. Another object of this invention is to make the educational process more flexible, efficient and enjoyable for teachers, students, and parents alike.

The invention is an SaaS platform for use by every level of a nationwide educational system, to be made available on a per-user subscription fee basis. According to one embodiment of the present invention, a group of servers connected to a network such as the internet runs programs that combine to create an SaaS platform. Users from every part of an educational system can log onto that SaaS platform using a set of client devices, which can be computers, netbooks, smartphones, tablets, or any other device enabled to connect to the network. Part of that platform is a User Account Management Component that manages user accounts and groups them into user groups based on the level within the educational system of the user's workplace, and the user's purpose within the educational system (e.g. administrator, teacher, student, or parent, among other roles), and controls users' access to the services offered by the platform based on their user account and user group information. A second component, called the Service Delivery Component, provides users with cloud-based services that support their needs within the educational system, such as word-processing functionality for writing papers and memoranda, productivity tools, reporting capabilities, and other educational activity services. The Directory Management Component manages the allocation of data, services, or applications within the servers' memories and the users' ability to access such data, services, or applications. The Data Storage Component manages the storage of data in a database accessible to the servers. The Network Communication Component passes data to client devices for display, and receives data from the client devices to operate the tasks coordinated by the Service Delivery Component. The client devices are expected to be able to transmit data entered by the users over the network to the Network Communication Component, and to display the data the Network Communication Component passes over the network to the client devices, and are configured to do so. A database is also part of the system, and is connected to the servers, and stores user account data, user group data, and data that the user stores during the course of using the platform.

In a related embodiment, the User Account Management Component is configured to make part of the platform private by restricting access for the use of that part to a particular population of users. Another embodiment configures the Service Delivery Component to provide an electronic mail system, and configures the Network Communication Component to send and receive electronic mail message contents. In an additional embodiment, the Service Delivery Component provides a platform for instant messaging, including video communication, and a virtual whiteboard system for graphical collaboration, while the client devices are equipped with digital video and audio input and output devices to capture the audio and video signals necessary to engage in video chat, and the Network Communication Component is configured to stream audio and video signals from one client device to another, and to convey text messages and graphics for instant messaging and virtual whiteboard. In another embodiment, the client devices are equipped with digital video cameras and audio input and output devices to capture live streaming of educational content, which the Network Communication Component is configured to stream, and the Service Delivery Component is configured to support. Still another embodiment configures the Service Delivery Component to provide on-demand video of pre-recorded or external educational content, while the Directory Management Component stores the on-demand video files and the Network Communication Component streams the video and audio data from those files to client machines for display. An additional embodiment involves configuring the Service Delivery Component to provide a platform for the online administration, evaluation, and grading of exams. Another embodiment configures the Service Delivery Component to provide a platform for games and recreation, for the purpose either of delivering information by entertaining means, or of rewarding successful learning behavior by students. A further embodiment involves configuring the Service Delivery Component to allow users and user groups to create their own web pages, for example by allowing them to select from templates of page layout and color schemes created with their functional role and age group in mind, and configuring the Directory Management Component and Data Storage Component to give users their own data storage space. An additional embodiment involves configuring the Service Delivery Component to provide administrative services and to generate reports for administrative purposes. Yet another embodiment permits attendance tracking: it contains a client device at a known location, either because it is fixed there or because it has navigation facilities and can inform the servers; the Network Communication Component is further configured to accept user credentials entered on that client device, the Service Delivery Component is set up to accept the user credentials from the Network Communication Component and combines them in a data file containing the date and time of their entry and the client device's known location. The Data Storage Component or Directory Management Component are configured to store the data file in the database or in the memory of the servers. Finally, in one embodiment of the system, the User Account Management Component allows the top-level administrator to set access levels for other users, which includes the ability to permit other users to set access levels for some subset of the system's users.

Also claimed is a method for implementing a nationwide software-as-a-service educational platform, which involves providing a group of servers and databases combined to form cloud-based SaaS infrastructure and a group of client devices connected to the SaaS infrastructure via a network such as the internet. The database maintains a collection of user roles organized into user groups divided into a first tier corresponding to the top-level educational authority, a set of tiers representing intermediate educational authorities, and a final tier representing individual schools, and further divided according to user roles in the database, along with set of user accounts and associated user account data. The database also contains any data related to users' work, study, or other use of the system. The method also involves having each user log on with unique credentials (such as a username and password), which the servers receive over the network and use to look up the user account information and the services or data the user is entitled to access, which is passed back to the client device and displayed in some way. The user selects services to use or modifies data, which the system performs or stores to the database, respectively; data is also stored to the database as needed by the services run for the user.

In a related embodiment, the users' access rights with regard to restricted portions of the SaaS platform are determined prior to allowing the user to view and select available services. Another embodiment involves providing electronic mail to users. An additional embodiment involves providing instant messaging with integrated video, audio, virtual white-board and text capabilities. Still another embodiment involves providing real-time video streaming of educational sessions or live events. Yet another embodiment involves providing on-demand video streaming of educational content. Under an additional embodiment, the system administers exams electronically and permits the evaluation of the exams and the posting of exam results. Yet another embodiment involves providing online games and other recreational activities. Another embodiment lets users create web pages for themselves and user groups, and allows users to store data in their own space in the server memory or database. An additional embodiment involves providing administrative services and generating reports for administrative purposes. Another embodiment involves tracking attendance by accepting user credentials at a client device whose location is known, combining them with that known location in a data file with the date and time their entry, and storing the data file in a database or in server memory. A final embodiment allows a top-tier user to modify access permission data in the user accounts corresponding to other users, including access permission data regulating those users' ability to modify access permission data belonging to other users.

Other aspects, embodiments and features of the invention will become apparent from the following detailed description of the invention when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE DRAWINGS

The preceding summary, as well as the following detailed description of the invention, will be better understood when read in conjunction with the attached drawings. For the purpose of illustrating the invention, presently preferred embodiments are shown in the drawings. It should be understood, however, that the invention is not limited to the precise arrangements and instrumentalities shown.

FIG. 1 is a flow chart illustrating some aspects of the claimed method.

FIG. 2 is a schematic diagram of a programmable electronic device, such as the servers and client devices that support the claimed system.

FIG. 3 is a schematic diagram of the claimed system's SaaS architecture, which illustrates some aspects of the claimed system.

FIG. 4 is a diagram illustrating the structure of the user groups which organizes the system.

### DETAILED DESCRIPTION OF SPECIFIC EMBODIMENTS

The disclosed invention is a cloud-based SaaS platform designed to support every facet of a nationwide educational system, from top-level administration and curriculum design down to individual teachers, students and parents at local schools. The SaaS services will be available to the educational system on the basis of a per-user periodic subscription model. The services will be presented to students in particular using a colorful and friendly interface with age-appropriate design and content, while administrators and teachers can enjoy a more professional interface. Users of all kinds will have the opportunity to customize their own web pages, and thus adjust their point of entry into the system to fit their own tastes. This SaaS platform will reduce information technology and related costs for the entire educational system, while improving security, robustness, and flexibility for every level of education, administration, and other areas within the system.

Definitions. As used in this description and the accompanying claims, the following terms shall have the meanings indicated, unless the context otherwise requires.

“Nationwide” means encompassing the educational system of an entire nation, state, province, or administrative division, from the top government department or secretary in charge of education to the individual school districts and schools within that nation, state, province or administrative division.

A “functional area” of an organization is a portion of that organization which is segregated according to the type of function its members perform for the organization. Functional areas include, without limitation, general administration, finance, development, curriculum design, legal counsel, pedagogy, students, and parents.

“Exams” are any examinations, quizzes, tests, or assessments used to test the knowledge and skills a student is expected to learn in a given course of instruction.

“Function-related tasks” are tasks performed by a set of computer programs to aid a user or group of users in performing the duties that fall within the scope of their role within the organization. Examples of function-related tasks include without limitation productivity tools comprising word-processing tasks, accounting tasks, spreadsheets, communication tools such as electronic mail, instant messaging, and video messaging, video and audio streaming tasks, student record management tasks, course information posting tasks, and tasks involving accepting student assignments and posting grades and other teacher reports.

“Function-related data” is any data generated by, input for, and stored for, function-related tasks, in forms including without limitation word-processing files, Portable Document Format (PDF) files, image files, text files, video files, audio files, numerical files, specialized program data files, binary data, and comma separated value (CSV) files. Function-related data includes all administrative, financial, and curriculum-design documents, spreadsheets, memoranda, videos, messages, and message logs, as well as all academic information, including student records, assignments, syllabuses, grades, schedules, calendars, and lesson plans.

“Credentials” is any data that can be used to identify a particular user, including the user's name, social security number, or any string of symbols associated with the user. Credentials are unique if there is no other user with the same credentials recorded in the system.

“User account data” is data that contains a user's credentials and describes individual user accounts, user roles, and user groups, and access permission data comprising a list of data and function-related tasks to which the user identified in said user account is entitled access.

An “electronic device” is any computer, mobile phone, PDA, server, or other device powered by electricity that may be programmed to perform arithmetic and logical operations.

A “server set” is a group of electronic devices designed to operate together as a single server from the perspective of a user communicating with the server set. Individual servers within the server set can be assigned particular roles, for instance to provide backup, load-balancing, and other processing and data persistence distribution schemes, or to provide machines dedicated to particular specialized processing tasks such as video streaming.

A “client device” is an electronic device configured to perform client-side tasks for a network-based system, including displaying data conveyed from servers via a network, and sending data entered by a user over a network to servers. In addition to devices like computers, tablets and smartphones utilized by users to access the SaaS platform, client devices may be projectors, printers, and digital signage panels, or anything else that receives data from the SaaS platform and displays, prints, or otherwise proffers that data to users.

A product or means is “coupled” to an electronic device if it is so related to that device that the product or means and the device may be operated together as one machine. In particular, a piece of electronic equipment is coupled to an electronic device if it is incorporated in the electronic device (e.g. a built-in camera on a smartphone), attached to the device by wires capable of propagating signals between the equipment and the device (e.g. a mouse connected to a personal computer by means of a wire plugged into one of the computer's ports), tethered to the device by wireless technology that replaces the ability of wires to propagate signals (e.g. a wireless BLUETOOTH® headset for a mobile phone), or related to the electronic device by shared membership in some network consisting of wireless and wired connections between multiple machines (e.g. a printer in an office that prints documents to computers belonging to that office, no matter where they are, so long as they and the printer can connect to the internet).

“Data entry means” is a general term for all equipment coupled to an electronic device that may be used to enter data into that device. This definition includes, without limitation, keyboards, computer mouses, touchscreens, digital cameras, digital video cameras, wireless antennas, Global Positioning System devices, audio input and output devices, gyroscopic orientation sensors, proximity sensors, compasses, scanners, specialized reading devices such as fingerprint or retinal scanners, and any hardware device capable of sensing electromagnetic radiation, electromagnetic fields, gravitational force, electromagnetic force, temperature, vibration, or pressure.

An electronic device's “optical data entry means” is a component coupled to the electronic device that records images on an electronic image sensor, for instance using a digital camera, video camera, or scanner. Persons of ordinary skill in the art will be familiar with digital cameras that may be attached to computers to transfer images, cameras that operate while attached to computers (i.e. “webcams”), and the near-ubiquitous built-in cameras that come with mobile phones. Scanners that may be used with computers or other electronic devices have existed for decades, and are known to persons of ordinary skill in this invention's technical field. Furthermore, persons of ordinary skill in the art will be aware of cameras that can be attached to computers to transfer video that they have captured, digital video cameras that operate while attached to computers (e.g. “webcams”), and the digital cameras capable of capturing video that are built into many mobile phones.

An electronic device's “audio input and output devices” are components coupled to the electronic device that record acoustic data and encode it in a digital signal, or convert a digital signal originating on the electronic device into audible sound. Examples include microphones and headphones.

An electronic device's “manual data entry means” is the set of data entry components coupled to the electronic device that permit the entry of data by manual manipulation. Manual data entry means can include keyboards, mouses, touchscreens, track-pads, and signature pads.

“On-demand video content” is video content that is pre-recorded acquired from external sources, or is linked to, and can be streamed to a user at the time the user chooses to receive it.

“User authentication” is a process in which a user who claims to belong to a particular credentials is required to prove his or her identity using secret information, passwords, biometric information, hard or soft tokens, or other known network-based authentication means.

“Email message data” is any data that is contained in electronic mail messages, including text, text formatting instructions (e.g. hypertext markup language), and image, PDF, or binary data extracted from electronic mail attachments.

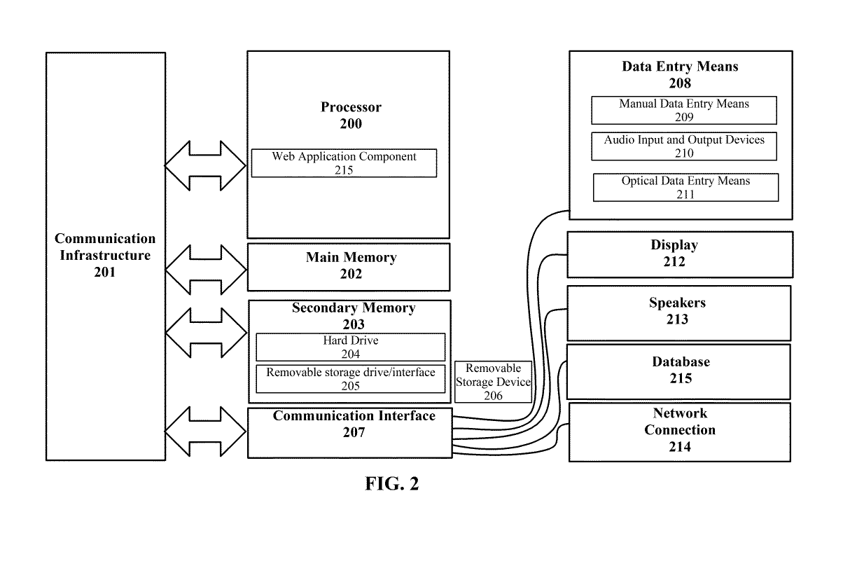

The claimed method and system are best understood by reference to cloud architecture, which consists of two sets of electronic devices, connected by a network: the client devices, by which end-users access the system, and the servers, a collection of which perform essentially all of the computing, security, and data storage tasks that the system requires. An exemplary electronic device is illustrated by FIG. 2. The processor 200 may be a special purpose or a general purpose processor device. As will be appreciated by persons skilled in the relevant art, the processor device 200 may also be a single processor in a multi-core/multiprocessor system, such system operating alone, or in a cluster of computing devices operating in a cluster or server farm. The processor 200 is connected to a communication infrastructure 201, for example a bus, message queue, network, or multi-core message-passing scheme.

The electronic device also includes a main memory 202, such as random access memory (RAM), and may also include a secondary memory 203. Secondary memory 203 may include, for example, a hard disk drive 204, a removable storage drive or interface 205 connected to a removable storage unit 206, or other similar means. As will be appreciated by persons skilled in the relevant art, a removable storage unit 206 includes a computer-usable storage medium having stored therein computer software and/or data. Examples of additional means creating secondary memory 203 may include a program cartridge and cartridge interface (such as that found in video game devices), a removable memory chip (such as an EPROM, or PROM) and associated socket, and other removable storage units 206 and interfaces 205 which allow software and data to be transferred from the removable storage unit 206 to the computer system.

The electronic device may also include a communications interface 207. The communications interface 207 allows software and data to be transferred between the electronic device and external devices. The communications interface 207 may include a modem, a network interface (such as an Ethernet card), a communications port, a PCMCIA slot and card, or other means to couple the electronic device to external devices. Software and data transferred via the communications interface 207 may be in the form of signals, which may be electronic, electromagnetic, optical, or other signals capable of being received by the communications interface 207. These signals may be provided to the communications interface 207 via wire or cable, fiber optics, a phone line, a cellular phone link, an RF link or other communications channels. The communications interface in the system embodiments discussed herein facilitates the coupling of the electronic device with data entry means 208, including manual data entry means 209, audio input and output devices 210, and optical data entry means 211. The communications interface 207 also connects the device to the device's display 212 and speakers 213. Finally, and crucially for the instant invention, the communications interface 207 enables the device to be connected to networks 214 including the internet, and to databases 215. It should be noted that each of these components coupled to the device via the communications interface 207 may be embedded in the device itself in some embodiments.

Computer programs (also called computer control logic) are stored in main memory 202 and/or secondary memory 203. Computer programs may also be received via the communications interface 207. Such computer programs, when executed, enable the processor device 200 to implement the system embodiments discussed below. Accordingly, such computer programs represent controllers of the system. Where embodiments are implemented using software, the software may be stored in a computer program product and loaded into the electronic device using a removable storage drive or interface 205, a hard disk drive 204, or a communications interface 207.

Persons skilled in the relevant art will also be aware that while any electronic device of this type must necessarily comprise facilities to perform the functions of a processor 200, a communication infrastructure 201, at least a main memory 202, and usually a communications interface 207, not all devices will necessarily house these facilities separately. For instance, in some forms of electronic devices as defined above, processing 200 and memory 202 could be distributed through the same hardware device, as in a neural net, and thus the communications infrastructure 201 could be a property of the configuration of that particular hardware device. Many devices do practice a physical division of tasks as set forth above, however, and practitioners skilled in the art will understand the conceptual separation of tasks as applicable even where physical components are merged.

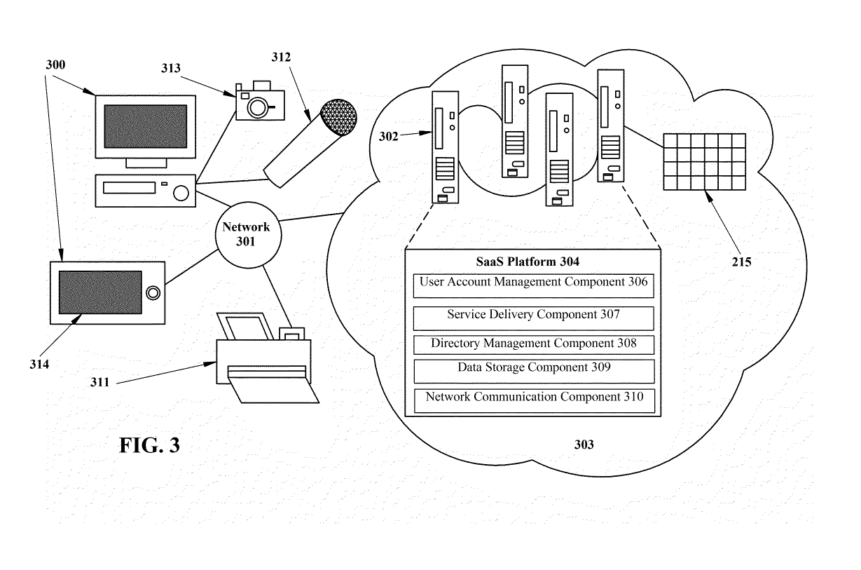

The disclosed system involves configuring a set of electronic devices as defined above to run a kind of web application configuration known as “software-as-a-service” (SaaS). Persons of ordinary skill in the art will recognize a web application as a particular kind of computer program system designed to function across a network, such as the internet. A schematic illustration of the present invention's SaaS web application platform is provided in FIG. 3. The SaaS application is designed to work with variably-sized and shifting set of client devices 300, which are electronic devices as described above. The client devices 300 are connected via some form of network connection to a network 301, such as the internet. Also connected to the network 301 is a set of server devices 302, which are also electronic devices as described above. The server set 302 and related devices appear to the client devices 300 as a single unit, the details of whose inner workings are invisible to the client devices 300, often referred to as the “cloud” 303. To function, the SaaS application requires computer programs on both the client devices 300 and on the server set 302. The programs running on client devices 300, however, are limited to user interface tasks: the only purpose of the client device programs is to relay user input to the cloud 303 via the network 301 and to display output the cloud 303 produces. The rest of the tasks the SaaS application is designed to perform will be performed within the cloud 303 by the server set 302. The server set 302 runs the “business logic” programs, saves files and other data produced by those programs in the server set 302, and maintains directories and databases.

To further illustrate the SaaS concept, imagine creating a word processing document. On a traditional computer, all tasks would be accomplished on the user's personal computer. Thus, the user would open a word processing program on his or her computer FIG. 2 and type words into the program using the computer's keyboard 209. While the word processor was in use, the words typed into it would be maintained in random access memory 202 on the computer, and when the user saved the file, it would be stored in a directory of files created on the computer's hard drive 204. In an SaaS word processor FIG. 3, the user would command the word processing program to open from his or her computer 300, but the program would actually open and begin to run on the server set 302. As the user typed in words, they would be transmitted to the word processor on the server set 302, which would keep them in main memory on the server set 302, and save them to a directory maintained on the server set 302 when the user saved the document. The server set 302 would also send updated display data upon any change to the contents of the document, so that the user's computer 300 could display the changes as they occurred. Except when the document was open, there would be no trace of it on the user's computer 300; the user experience of word processing would be the same, but the user's computer 300 would only send typed characters to the server set 302 and display whatever the server set 302 sent back over the network 301.

As a result of the SaaS architecture, the server set 302 must be constructed to perform the bulk of the processing and all of the data storage for a large and variable number of users at client devices 300. This creates challenges with regard to the distribution of processing and data tasks. To get the most performance out of the server set, processing tasks must be distributed evenly between servers 302. Likewise, the data that is stored on directories in machine memory, as opposed to on a database 215, must be distributed evenly to take advantage of all the available storage capacity, and must also be readily accessible to each server. An additional challenge presented by SaaS architecture is its creation of a single point of failure: in traditional computing, when a hundred thousand users are working on their computers and the business logic program on one computer fails, only one person is unable to work. If the SaaS server set goes down while one hundred thousand people are using it via their client devices, all one hundred thousand users could potentially be affected. For this reason, the distribution of data and processing tasks among the servers must also create redundancy, so that the failure of any one electronic device does not impede the users' ability to continue using the system. Implementations known to persons skilled in the art already exist to address these issues, including load balancing services, DNS round-robin techniques, and other approaches to efficient and redundant division of processing tasks and data.

The use of SaaS to provide an education support platform also creates many advantages. The first is the potential seamless integration of an entire school system hierarchy: the addition of an SaaS system to existent networks at schools is virtually costless in terms of hardware, and if any school introduces new devices for its faculty or students (e.g. by deciding to use tablets to replace textbooks, as some schools have considered doing), those new devices can become client devices without any significant reduction of their capacity for other tasks. Students, teachers, and other officers and employees can move at will within the school system; their data is available to them no matter where they access it. On the other hand, some categories of data can be made available to particular officers based upon their office; this is particularly useful with regard to political appointees, who can come and go quite rapidly with changes in the political climate, causing inherent continuity issues.

The concentration of processing tasks and data with a single entity, if implemented competently, can make the computing system as a whole far more robust. Because the entity in charge of operating the server set 302 specializes in that role, it can dedicate more time, money, and expertise both toward network security and disaster contingency planning. The facility or facilities operating the servers can have backup power generation options, for instance. Another advantage conferred by the use of SaaS is that the client device machines can be very simple in comparison to more typical personal computers, because their required capabilities will be limited to user interface and network communication tasks. Thus, the acquisition of client devices can be very inexpensive for the schools that use them, and the cost of theft if a client device is stolen is also low, relative to what it would cost if a general purpose computer were stolen.

The most basic embodiment of this invention is a system FIG. 3 made up of a server set 302 connected to a network 301, and a set of client devices 300 connected to the same network. The server set 302 contains a set of computer programs as described above; when the server set operates together according to one of the protocols discussed above, the computer programs on the servers combine to create an SaaS platform 304. The tasks performed by the SaaS platform 304 are best classified by dividing it conceptually into component parts. The Network Communication Component 310 is directed to sending data to the client devices 300, including items such as printers 311, and receiving data from them via the network 301. The data the Network Communication Component 310 sends to the client devices 300 all essentially relates to display and other user-interface tasks. The data the Network Communication Component 310 receives from client devices 300 is essentially limited to user-input data to be processed on the SaaS platform. For example, if a user is working on a word processing program, the client device 300 might send the user's characters as they are being typed to the Network Communication Component 310, which would send updated display data back to the client device 300 to show the user the updated document. The characters typed by the user, meanwhile, are passed by the Network Communication Component 310 to other components of the SaaS platform, to perform the non-user-interface related tasks required of a word processor program.

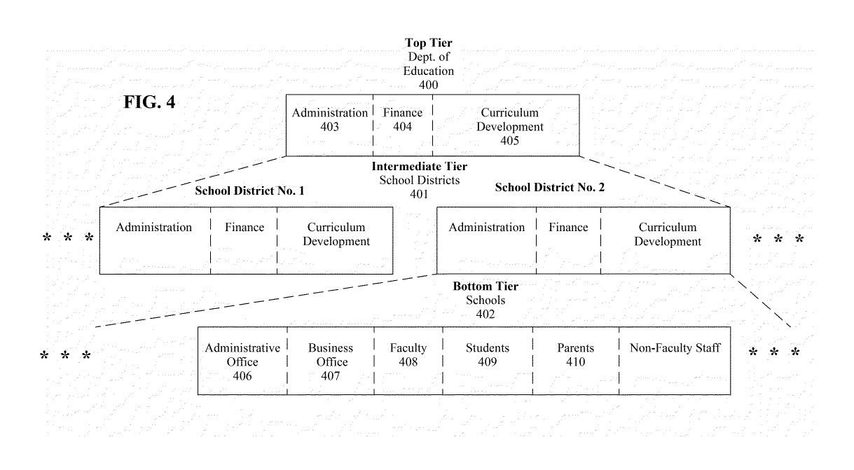

The User Account Management Component 306 is the portion of the SaaS platform directed toward coordinating the provision of software options to users based on their places in the organizational hierarchy and their professional roles. To that end FIG. 4, the user accounts are first gathered into tiers reflecting the organizational level to which each user account belongs. Any member of the governmental department overseeing the entire educational system, for instance, would be grouped together in the top tier 400 representing that governmental department. The bottom tier 402 would be occupied by users associated with individual schools, including employees of the school, students, and parents. In between the top and bottom tiers are users who work at intermediate levels 401 within the organization as a whole; one intermediate tier 401, for example, might consist of all persons who work at the school district level. The tiers are further divided into user groups based upon functional area. For example, the governmental department overseeing the education system as a whole would have an administrative user group 403 including the top-level appointee to whom the whole educational system reported, a financial user group 404 containing the people who coordinated financial decisions for the educational system as a whole, a curriculum design group 405 for the people who designed curricula, or oversaw their design, for the educational system as a whole, and so forth. The tier representing the individual schools might be divided into one user group for teachers 408, another for students 409, and another for parents 410, but would also have a user group for the school's administrative staff 406, and another for its business staff 407, and so forth. How finely the user groups are divided is an implementation-specific decision. Additional user accounts and groups can also exist for some former employees, students, or parents, as well as other categories of people who are less directly involved in the educational system. User access to particular software products within the platform may be dictated by user group membership, and thus decisions about how to organize user groups should reflect decisions about which set of people should share which common software. It might be prudent, for example, to create separate user groups for the teachers of separate schools. Alternatively, teachers could be organized into groups based upon subject matter, so that, for instance, all math teachers shared a group, which could provide them access to math-related tools unnecessary for other disciplines. Of course FIG. 3, for this to work each user account must itself enable the User Account Management Component 306 to ascertain the corresponding user's tier and functional area, and so that information, together with the user's name and other personal information, must be part of the user's account information, along with some unique credentials to allow the user to be differentiated efficiently from all other users. The User Account Management Component 306 may also be organized to customize access to software for each user account, to combine the efficiency of a preselected suite of applications with the flexibility necessary for a user to innovate in his or her own right. The User Account Management Component 306 could also facilitate the creation of larger families of user groups; for instance, ever user involved in finance at every level of the organization could share certain resources with every other such user regardless of location within the hierarchy. Horizontal integration of user groups within a tier is also a possibility. For instance, instructors, parents, and students could share some resources relating to classes. Either kind of integration merely involves choosing what services to deliver for each user group.

The Service Delivery Component 307 of the SaaS platform coordinates the provision of software to users as directed by the User Account Management Component 306. This is the central purpose of the SaaS platform: the provision of all the software tools, or function related tasks, necessary for a person within the educational system to accomplish his or her goals. The Service Delivery Component 307 is the set of all tasks relating to processing the software the users utilize, from operating word processing programs that practically all users will need to write documents to generating the digital signal data for video streaming. One way to implement the Service Delivery Component 307 in practice could be as a collection of separate software products with a system overlying them to permit users to execute and terminate execution of those programs. As such, it will work closely with the Directory Management Component 308, whose purpose is to organize software and data on the servers into a directory structure to enable applications, and users, to locate them. One example of such a directory structure that should be familiar to persons of ordinary skill in the art is the directory tree commonly used in personal computer systems, which places all files in a recursive data structure that programs can traverse efficiently. A directory tree or similar object can also be made visible to the user via a command-line or graphically as a set of folders. By those or similar means, the Directory Management Component 308 can give users direct access to data files stored in the servers' memories. The permission to modify or execute files in such a visible directory system can be regulated according to user account data by the User Account Management Component 306.

In addition to data stored in the directory system implemented by the Directory Management Component 308, the SaaS platform will be able to store data to a database 215. A database 215 is any structured collection of data. As used herein, databases can include “NoSQL” data stores, which store data in a few key-value structures such as arrays for rapid retrieval using a known set of keys (e.g. array indices). Another possibility is a relational database, which can divide the data stored into fields representing useful categories of data. As a result, a stored data record can be quickly retrieved using any known portion of the data that has been stored in that record by searching within that known datum's category within the database 215, and can be accessed by more complex queries, using languages such as Structured Query Language, which retrieve data based on limiting values passed as parameters and relationships between the data being retrieved. A database can be created in any digital memory. The Data Storage Component 309 is the portion of the SaaS platform dedicated to writing data to the database 215 and querying the database 215 to retrieve data. In particular, the Data Storage Component 309 stores the user account data and the other user group-related data necessary for the User Account Management Component 306 to perform its function. The Data Storage Component 309 can also store function-related data as necessary for function-related tasks. Note, however, that in practice, individual applications performing function-related tasks could also manage their own data storage. The data pertaining to a give user stored in a database or on the server directories could be exported to a different system or reallocated to a different place within the directories or databases of the system, when a user moves from one role to another, or leaves entirely. For example, matriculation between grades and graduation could imply a movement of data from one location to another, and students who pass beyond the coverage of the system upon graduation or transfer could expect their data to travel with them to whatever other system exists at the new institution.

It is worth noting that the User Account Management Component 306, Service Delivery Component 307, Directory Management Component 308, Data Storage Component 309, and Network Communication Component 310 need not be separate entities or modules within a particular program as implemented. The purpose of their status as elements in the system described herein is to establish that the servers 302 must be configured to perform their functions as set forth, but not to dictate the architecture of a particular implementation. Thus the functions of each Component could overlap, or be spread across various stand-alone applications that also perform the functions of another Component.

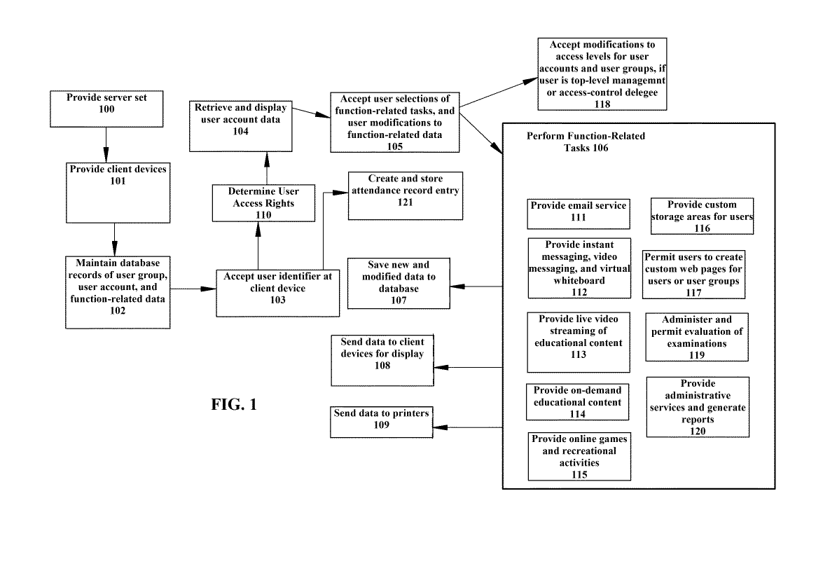

A method FIG. 1 for operating a system as described above involves maintaining user account data, user group data, and function-related data on a database 102. The database, a set of client devices 101, and a server set 100 are all connected using a network. As before, the client devices 101 would likely be a large and variable group of machines whose locations were immaterial so long as they were connected to the network. Likewise, as before, the server set 100 could be in a single server farm or in scattered locations. A user signing onto the client device 103 has his or her credentials passed over the network to the server set, which retrieves the user account data 104 associated with the user credentials. The use account data is displayed 104 to the user. The manner of the display 104 depends on the implementation. The user account information displayed could be limited to a menu or other presentation of function-related task options available to the user according to the user account data, for example. The user could choose to view further account details under some implementations, perhaps by selecting a “your account” link. Alternatively, the user's entire account could be displayed on a single page, from which the user could navigate to any user account data, function-related data, or function-related tasks that the user is authorized to access. The user selects a function-related task, or modifies function-related data 105. The system then performs function-related tasks 106, saving any modified or new data to the database 107, and sending data to client devices for display 108 and printing 109, or other client-side uses.

Access to Cloud platforms FIG. 3, 304 typically follows one of four deployment models: public cloud infrastructure, community cloud infrastructure, private cloud infrastructure, and hybrid cloud infrastructure. A public cloud infrastructure is meant for use by the general public. Use of a community cloud infrastructure is limited to users from a particular community of persons from organizations that have shared concerns; one example would be the community of persons in the field of education. Access to services on a private cloud infrastructure is limited to persons who are members of a single organization. Finally, a hybrid cloud infrastructure combines elements of at least two of the other three kinds of cloud infrastructure. Each of these can be seen as restricting access to the Cloud platform to a certain degree: public clouds have no access restrictions as to the services offered, although they should ideally protect individual users' data from inspection by unauthorized persons. Private, community, and hybrid clouds restrict access to some or all of the services offered, with differences in the restriction criteria accounting for the difference between private and community cloud infrastructure. To permit the instant invention to be implemented according to any of these four deployment models, some embodiments configure the User Account Management Component 306 to restrict access to some portion of the SaaS platform 304. If the desired implementation is a private or community cloud, the User Account Management Component 306 can be configured to deny access to the entire SaaS platform 304 to users who are not members of the authorized population. The authorized population might include members of the educational system, some portion thereof, or some larger community containing the whole or a portion of the educational system. If a hybrid cloud is preferable, some parts of the SaaS platform 304 will not be restricted, or else the restrictions on access to those parts will be according to differing criteria, and if a completely public cloud is the ideal choice, authentication need not be required at all. As an example, there could be some function-related tasks that use a large amount of system resources. Placing those function-related tasks within a private portion of the SaaS platform 304 restricted to employees and students within the educational system would help a system administrator control the amount of traffic those function-related tasks would see, ensuring that the people who really need to use them will receive high-quality performance. The equivalent method embodiment FIG. 1 involves a step of checking 110 whether the user qualifies for access to a restricted section of the SaaS platform prior to retrieving services to which the user is authorized access.

One very useful feature of the claimed SaaS platform is its ability to support communication over the network. Some embodiments of the disclosed invention accomplish this by providing an electronic mail (email) application as part of the Service Delivery Component 307. Email is known to practitioners of ordinary skill in the art as a system for passing digital messages over a network, using a protocol such as the Simple Message Transfer Protocol. The messages may contain text, images, and attached files of various types. Implementations of the instant invention could involve permitting email to be passed between registered users only, or permitting email to be used in the conventional sense, permitting messages to be passed to any email address anywhere in the world. The Network Communication Component 310 must be configured to convey email message data for display on client devices 300, and receive data from client devices 300 to insert into email messages. The platform 304 can also generate contact lists automatically for users based on user group affiliations and relationships with other user groups. For instance, a parent's contacts could be populated with the email addresses of the parent's children, their instructors, and other employees of the school the children attend with whom the parent is likely to communicate. The equivalent method embodiment involves providing email service 111 as part of the performance of function-related tasks 106.

An additional feature of the SaaS platform enables users to engage in a virtual conversation using the platform's services. This is accomplished by including an instant-messaging platform in the Service Delivery Component 307. Instant messaging, as persons of ordinary skill in the art will know, is a form of network-based communication in which users can send each other messages nearly instantaneously. The most basic form of instant messaging involves sending text messages between the users involved in the chat session; although it is common for only two users to communicate at a time, instant messaging systems can pass messages between members of larger groups. Thus, an entire class of students could engage in a discussion on the Service Delivery Component's 307 instant messaging platform. Where the client devices 300 are coupled to audio input and output devices 312, the instant messaging platform could permit audio chatting, allowing users to engage in a kind of conference call between client devices 300. Video chatting can also be enabled by the use of digital camera means 313 coupled to client devices. Finally, the instant messaging platform could provide a virtual whiteboard, which is a program that simulates a physical whiteboard by allowing multiple users simultaneously to see an image, and to modify it, for instance by drawing images on it via their client devices' manual data entry means 314. All of the collaboration sessions, whether they are text chats, video discussions, or graphical collaborations on whiteboards, can also be saved by the Directory Management Component 308 or the Data Storage Component 309, so that they can be read, or in the case of video discussions, played back, later. The Network Communication Component 310 is configured under these embodiments to stream audio and video signals between users for video and audio chatting, and to convey text and image data for the virtual whiteboard and text chatting systems. The corresponding method embodiment FIG. 1 involves providing instant messaging, video messaging, and virtual whiteboard 112 as part of the provision of function-related tasks 106.

One way a robust, network-based system can really add value to the educational experience is through the use of remote instruction. The system FIG. 3 under one embodiment incorporates a video platform into the Service Delivery Component 307 that allows instructors to conduct lessons over the network. The client devices 300 are equipped to receive and display the audio and video signals that the Network Communication Component 310 is configured to route from the instructor's client device 300 via the network 301. The client devices 300 of both the students and the teachers can also be configured to capture and transmit video and audio signals from digital camera means 313 and audio input and output devices 312 coupled to the electronic devices 300. The degree to which students can interact in the lesson will be an implementation-specific issue, and would likely vary according to the teachers' teaching styles. A lecture-based approach, for instance, might accept student questions and comments in a queue that the teacher could read through and address at appropriate junctures in the lecture. At the other extreme, a discussion-based classroom could be simulated by allowing every student to participate fully with audio and video signals from their own client machines 300. The method FIG. 1 embodiment of this feature involves providing live video streaming of educational content 113 as part of the provision of function-related tasks 106. This can also be combined with the instant messaging and virtual whiteboard capabilities discussed above to allow for more student and teacher contributions during the lesson.

A related feature to the live streaming of instruction is the ability to stream archived lessons on demand. This is useful for a number of reasons, not least that students who miss either classroom or virtual lessons due to emergencies or other unexpected absences can view the lessons later, so that they don't miss vital information. To accomplish this in the system FIG. 3, the Service Delivery Component 307 is configured to provide on-demand video content, by permitting user access to audio-video files. The Network Communication Component 310 must be configured to permit users to select a file to stream from their client devices 300, and to stream the content provided to the Network Communication Component 310 by the Service Delivery Component 307 over the network 301 to the client devices 300. The Directory Management Component 308 must likewise be configured to store and provide archived on-demand video files. The corresponding method embodiment FIG. 1 involves augmenting the delivery of function-related tasks 106 by providing on-demand educational content 114. Links to on-demand educational content may be made available on individual users' web pages or web pages of user groups.

Another useful feature provided by one embodiment of the instant invention FIG. 3 is the ability to administer examinations, quizzes, and tests online. To accomplish this, the Service Delivery Component 307 must be configured to include a platform for the administration of examinations to students. This can be accomplished by providing a series of questions with answer options or text entry boxes, which can be relayed to the students' client devices 300 by the Network Communication Component 310, which can receive the students' answers in turn; the answers can be recorded into memory by the Service Delivery Component 307. The user interface protocols necessary for such a process are well-known to persons skilled in the art; examples include Hyper Text Markup Language form submissions, as well as any number of graphical interface protocols. Another feature that could be included in the examination administration platform is a timer, which could use the server set's timekeeping ability to keep track of each student's elapsed time taking an examination, send a count-down display to the student's client device 300, and automatically terminate the student's access to the examination answer options when the allotted time has elapsed. The student's access to other materials within the system can also be curtailed by the User Account Management Component 306 throughout the examination; alternatively, students could access some or all of their notes, electronic texts, or other materials during open-book sessions. Finally, each student's answers could be accessible to the instructor who is responsible for evaluating and grading them; some implementations could allow the instructor to add comments to the students' work, and there could be tables for the posting of immediate and cumulative scores. A corresponding method embodiment FIG. 1 would include the inclusion of examination administration and evaluation 119 in the function-related tasks provided.

Another useful feature of the present invention is calculated to enhance students' learning potential by providing games and other online activities. To that end, the Service Delivery Component 307 in one embodiment FIG. 3 is configured to include an activity platform. On the platform, students could access and play games whose content is designed to test knowledge and skills the students should be acquiring, and to enhance their acquisition of such knowledge and skills by providing them with an enjoyable method of learning and practice. Games or activities need not be explicitly educational or even directly related to any particular class; some games, such as chess, enhance core intellectual skills within a system of rules and strategies bearing no explicit resemblance to the outside world. Furthermore, some recreational activities on the platform could be created solely for the purpose of enjoyment, and offered as rewards for educational attainment, attendance, or any other goal a student has met. This feature thus can help create incentives for diligence and good study habits. Depending on the kind of recreational activity involved, the Network Communication Component 310 might be required to convey animations, video streaming, audio streaming, images, and other graphical data. The User Account Management Component 306 could also be configured to limit or allow access depending on the student's degree of achievement in matters the instructors have chosen to incentivize. The corresponding method embodiment FIG. 1 includes the provision of online games and other recreational activities 115 as part of the performance of function-related tasks 106.

Students, instructors, and other workers within the system could also benefit from the ability to store data in a space of their own. Some people could benefit, for example, from their own system of organization when studying for or planning courses. This is an ability that students and teachers take for granted when using their own local computer or paper systems. To give them the same ability, the system's Directory Management Component 308 and Data Storage Component 309 could be configured to provide space in which users could store data files of their own choosing, with content of their own creation, on the system FIG. 3. As part of the users' creation of custom data, the Service Delivery Component 306 could further permit the creation of custom web pages, both for individual users and for user groups. Thus, for instance, a user group representing all students learning pre-calculus could have a web page created by pre-calculus instructors, with customized information and instruction for the students. Likewise, each teacher and student could have his or her own web page, with whatever formatting and content that student or teacher chose to provide. The pages could, of course, be monitored for inappropriate content by any school administrator. Furthermore, the SaaS platform could provide templates with age and role-appropriate default appearance and content, some of which could be optional, and some of which could be mandatory, from which users could customize their own web pages. The corresponding method approach FIG. 1 involves allowing the users to use dedicated data storage areas 116 and permitting them to create custom web pages 117, as part of the provision of function-related tasks 106. The web pages could contain links to other facilities to which the web pages' users were permitted access by the system, including their instant or video messaging groups, course video links, online texts and course notes, and other web pages related to the relevant course-load or administrative needs.

The instant invention is also intended to support the various administrative, financial, human resources, and curriculum-development workers who help coordinate and manage the educational system. To that end, the Service Delivery Component 307 may be configured to provide a set of administrative tools, such as human resources software that maintains automated applicant and employee records, tracks employee performance criteria for the benefit of managers, or allows employees to access and request the use of benefits such as medical leave. Other examples could include accounting facilities for use by employees and officers in charge of finance. Any or all of these applications or services can also be designed to generate reports. Reports are ordered collations of data that permit the reader to perceive patterns in the data. For instance, a report on the attendance records of students could collect all individual attendance records throughout the system, calculate the total unexcused absences for each school, and display the results to regional officer in charge of improving attendance, via the Network Communication Component 310, which is configured as discussed above to send any data to client devices for display. The officer would then be able to see at a glance which school had the greatest issues with truancy, and direct resources accordingly. The corresponding method embodiment involves providing administrative services and generating reports as part of the performance of function-related tasks 106.

The SaaS platform FIG. 3 can also be used to help track student attendance. This is accomplished by means of a client device 300 at a known location. What makes it a “known location” is the ability of the SaaS platform to generate or store data indicating the client device's location at any given time. The simplest way to do this of course is to fix the client device to a part of a building so it cannot be moved, and store its location in server memory 302 or the database 215 as a static datum. Alternatively, any client device that possesses GPS or other navigation facilities has the capacity to send its location to the SaaS platform 304, and can even do so automatically by adding the location as metadata to any data transmitted to the platform, in a process skilled practitioners in the art will know as “geotagging.” Then, if a user enters credentials in that client device, the Service Delivery Component 307 can be configured to accept the credentials, and combine them in a data file with the client device's known location. The Service Delivery Component 307 can also add the time and date that the credentials were entered, using the timekeeping facility that virtually all electronic devices possess. This data file can then be stored in the server memory 302 or the database 215 by the Directory Management Component 308 or the Data Storage Component 309, respectively. To track attendance, the students can be required to enter their credentials in a fixed client device 300 or on a client device of their own that possesses navigation facilities. The entry of credentials can be done manually via the client device's manual data entry means 314, but could also be stored on an RFID tag or similar readable device in the students' possessions, which could be read by a component designed to capture the credentials automatically from the readable device and transmit it to a coupled client device. In the case of machine-readable identification tags, the recording of user credentials could even be done automatically as a student walked through a doorway. Another possibility is accepting biometric data, such as fingerprints or retinal scans, and transmitting that biometric data to the client device, which accepts it as credentials. If the time of entry of a student's credentials is some period after the time at which the student was required to enter them, the entry would demonstrate that the student was tardy. If the student failed on a particular day to enter the credentials at all, the lack of an entry would indicate an absence; needless to say, the student could be given the opportunity to rebut these inferences. Combined with the report-generating ability discussed above, this system would allow administrators to generate absence and tardiness reports, showing absences and tardiness per student or adding them up for groups of students. The equivalent method embodiment FIG. 1 would involve accepting the user's credentials at a client device 103 of known location, combining them with the known location and date and time of entry to create an attendance record file 121, and then storing that file in either the server memory or the database.

To truly reflect the administrative hierarchy of an educational system, the claimed SaaS platform must give the top-level administrators the ability to control the platform's use, and to delegate that control to subordinates. The system FIG. 3 accomplishes this in some embodiments by configuring the User Account Management Component 306 to give the top-level management within the educational system the ability to set access permissions for all system users and user groups. Those access permissions would determine which of the services made available on the SaaS platform would be delivered to which users. As it would be impractical for the Secretary of Education to personally administer access for the entire system down to individual students and parents, the ability to delegate access control is also given to the top-level management. Specifically, the User Account Management Component 306 includes the ability to grant other users any and all of the top-level management's abilities to change access levels in the top-level management's abilities to change access levels. Thus, the top-level management need only delegate to each top-level manager on the tier below him or her the ability to control access levels for their area of governance; they in turn can use their delegated access control to delegate access control to the administrators of lower tiers, and so forth. In this way, the entire system can be managed by exactly the same hierarchy that manages the real-world educational system it is designed to reflect. The implementation of this approach can of course involve creation of a default delegation model by the administrators of the platform. It is not difficult to imagine, for instance, that the chief administrator of a school district should be able to set access levels within that district, and only within that district. The corresponding method embodiment FIG. 1 involves allowing the top-tier user to set access levels 118, as discussed above.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A system implementing a software-as-a-service educational platform for a nationwide educational system, comprising:
a server set connected to a network, each server an electronic device possessing a memory and a processor, said processors together operable to perform functions comprising:
a User Account Management Component configured to manage a set of user roles for individual persons organized into user groups according to the educational system's hierarchy into a first tier representing the top-level educational authority of said educational system, a set of tiers representing intermediate educational authorities, and a final tier representing individual schools, and further divided according to functional area, and a set of user accounts each comprising unique credentials and a user role, and further configured to grant each user access to function-related tasks and data based upon said user's user account data;
a Service Delivery Component, configured to perform function-related tasks for individual users and groups, and to provide a set of function-related tasks for each individual user to access and use based upon that user's user account data;
a Directory Management Component configured to operate a directory of user account data and function-related data on said server set;
a Data Storage Component configured to write data to and retrieve data from a database coupled to said server set, where said data includes user account data and function-related data; and
A Network Communication Component configured to transmit data including user account data, function-related data, and formatting and display data to client devices, to receive data from client devices, via said network;
a database coupled to said server set, configured to store user account data, user roles, user groups, tier and functional area information, and all function-related data; and
a population of client devices, each client device an electronic device coupled to data entry means including manual data entry means and possessing a memory and a processor, said processor operable to perform functions comprising receiving and displaying data including text, text formatting instructions, links, images, and streaming video, via said network from said server set, accepting data input by a user using data entry means coupled to said client device, and transmitting user-input data via said network to said server set;

2. A system according to claim 1, wherein said User Account Management Component is configured to restrict access to some of the function-related tasks provided by said Service Delivery Component.

3. A system according to claim 1 wherein said Service Delivery Component is configured to provide a communication platform for electronic mail, and wherein said Network Communication Component is configured to send email message data to said client devices for display, and to receive email message data from said client devices for incorporation in electronic mail messages.

4. A system according to claim 1 wherein said Service Delivery Component is configured to provide a communication platform for instant messaging with integrated video, audio, virtual white-board and text capabilities, and wherein said client devices are coupled to optical data entry means and audio input and output devices, and wherein said Network Communication Component is further configured to capture digital audio and video signals transmitted by said client devices via said network, and to stream said audio and video signals to said client devices.

5. A system according to claim 1 wherein said Service Delivery Component is further configured to provide a video platform for real-time streaming of educational content, and wherein said client devices are coupled to optical data entry means and audio input and output devices, and wherein said Network Communication Component is further configured to capture digital audio and video signals transmitted by said client devices via said network, and to stream said audio and video signals to said client devices.

6. A system according to claim 1 wherein said Service Delivery Component is further configured to provide a video platform for on-demand streaming of video content, said Directory Management Component is configured to store on-demand video content, and said Network Communication Component is further configured to stream said audio and video signals to said client devices.

7. A system according to claim 1 wherein said Service Delivery Component further includes an examination platform for the electronic administration of exams, and for evaluation and posting of results of said exams by instructors.

8. A system according to claim 1 wherein said Service Delivery Component further includes an activity platform for online games and other recreational activities.

9. A system according to claim 1 wherein said Service Delivery Component further includes a platform for the creation of group-specific and user-specific web pages, and wherein said Directory Management Component and Data Storage Component are configured to provide users with individual storage space.

10. A system according to claim 1 wherein said Service Delivery Component further includes a suite of administrative tools with reporting capabilities.

11. A system according to claim 1 further comprising a client device at a known location, and wherein said Network Communication Component is further configured to accept user credentials from said client device, and wherein said Service Delivery Component is configured to perform tasks comprising an attendance-tracking service, which accepts said user credentials from said Network Communication Component and combines said user credentials into a data file containing the date and time of their entry as generated by said server set and the client device's known location, and wherein said Data Storage Component or Directory Management Component is configured to store said data file in said database or in the memory of said server set.

12. A system according to claim 1 wherein said User Account Management Component is customizable by the highest level of management in said educational system to regulate access to any content, user group, user account, or access control facilities within said system.

13. A method for implementing a nationwide software-as-a-service educational platform, comprising:
providing a server set connected to a network;
providing set of client devices connected to said network;
maintaining in a database coupled to said server set a collection of user roles organized into user groups divided into a first tier corresponding to the top-level educational authority, a set of tiers representing intermediate educational authorities, and a final tier representing individual schools, and further divided according to functional area;
maintaining in said database a set of user accounts, and user account data associated with each user account;
maintaining function-related data in said database;
accepting each user's credentials at one of said client devices and passing said credentials to said server set via said network;
retrieving user account data associated with said user credentials from said database;
passing said user account data over said network to said client device;
displaying said user account data on said client device;
accepting user selections of function-related tasks or modifications to data; and
performing selected function-related tasks on said server set, displaying the results of said function-related tasks on said client device, accepting further data input on said client device from said user, saving modified or new data to said database, and sending data output by function-related tasks to other client devices.

14. A method according to claim 13, further comprising determining the user's access rights with regard to restricted portions of said software-as-a-service educational platform prior to said retrieval of user account data.

15. A method according to claim 13, wherein said function-related tasks comprise providing electronic mail service to said user.

16. A method according to claim 13, wherein said function-related tasks comprise providing instant messaging with integrated video, audio, virtual white-board and text capabilities.

17. A method according to claim 13, wherein said function-related tasks comprise providing real-time video streaming of educational content.

18. A method according to claim 13, wherein said function-related tasks comprise providing on-demand video streaming of educational content.

19. A method according to claim 13, wherein said function-related tasks comprise administering exams electronically and permitting the evaluation of said exams and the posting of exam results.

20. A method according to claim 13, wherein said function-related tasks comprise providing online games and other recreational activities.

21. A method according to claim 13, wherein said function-related tasks include permitting the user to create or modify user-specific or user group-specific web pages, and providing the user with individual storage place in said server sets' memory or on said database.

22. A method according to claim 13, wherein said function-related tasks comprise providing administrative services and generating reports.

23. A method according to claim 13, further comprising:
accepting user credentials at a client device whose location is known;
combining said user credentials and said known location in a data file with the date and time of entry of said user credentials in said client device; and
storing said data file in a database or in server memory.

24. A method according to claim 13, wherein said user is a member of the top-level tier and further comprising allowing said user to modify access permission data in the user accounts corresponding to other users.
